(19) United States
(12) Patent Application Publication
(10) Pub. No.: US 2012/0150654 A1
(43) Pub. Date: Jun. 14, 2012

(54) Method And Apparatus For Interactive Media Control

(75) Inventors: Ajay Sathyanath, Edison, NJ (US); Thyagarajan Nandagopal, Edison, NJ (US)

(73) Assignee: Alcatel-Lucent USA Inc., Murray Hill, NJ (US)

(21) Appl. No.: 12/963,518

(22) Filed: Dec. 8, 2010

(51) Int. Cl. G06Q 30/00

(52) U.S. Cl. 705/14.66

(57) ABSTRACT

A method and apparatus for controlling an interactive billboard. A billboard controller builds a UAP dataset, using the UAP dataset for audience estimation, and causing selected content to be displayed on one or more billboards based on the estimate. The UAP dataset preferably contain scored or ranked user association sets that associate users with content and other characteristics of detected interactions with the billboard.

### TECHNICAL FIELD

The present invention relates generally to the field of interactive media advertizing, and, more particularly, to a method and apparatus for estimating the likely audience for an interactive billboard at a given time so that the content displayed on the billboard can be selected appropriately.

### BACKGROUND

The following abbreviations are herewith defined, at least some of which are referred to within the following description of the state-of-the-art and the present invention.
ASP Advertising Service Provider
RoI Region of Interest
UE User Equipment
UAP User-Ad-Profile
UPS User Profile Server
WSP Wireless Service Provider

Billboards display advertising with the hope that it will have an impact on the numerous people expected to view it. Many billboards are static, that is, they display images that must be painted or applied onto them and that cannot be changed without some effort. Increasingly, however, billboards are configured mechanically or electronically to be able to quickly change the content that is being presented to the billboard's audience. The changing presentation not only helps to attract and hold the attention of the audience, but it can quickly be changed throughout the day to target certain people who may be present in the region of interest (RoI)—the area from which the content being presented may be perceived.

An advertising service provider (ASP) may produce and store advertising content that can be sent to the billboard operator, perhaps in response to a content request. A billboard controller is often present to make the request, receive the content, and cause the billboard to present it. A single controller may be used to control the operation of a number of billboards, each having their own location and RoI.

Naturally, billboard owners and advertisers want to target their advertising—presenting the right content at the right time—to have the maximum impact. An effort is often made to judge the audience that will view the billboard. This of course may be based on location; certain neighborhoods having a different demographic composition than others. For billboards that can be changed quickly, the time of day may also be a factor.

Many billboards also encourage interaction. Members of the billboard audience may be provided with a way to react to the content that is being presented. The billboard itself may have a keypad, touchscreen, or other user interface available for interaction. More commonly, viewers may send text messages or other communications using the mobile devices that many people now carry with them. Naturally, the billboard operator must provide some instruction to audience members on methods of interaction, usually in the presentation itself

A person interacting with a bill board provides direct evidence of their interest in the content being displayed. The aptness of the presentation to others in the RoI, however, is not so easy to detect. One method for judging the composition and interests of the audience is to request a census. The mobile devices now carried by many communicate through wireless networks, and many wireless service providers (WSPs) are now able to track with some precision the location of subscribers using their networks. WSPs can, and often do, provide this information as a service. The billboard operator may, for example, request that one or more WSP provide a census of the audience within a RoI. User-profile information may also be requested so that information stored in the profile may be used to select content for presentation on the billboard.

The audience in the RoI, however, may change frequently throughout the day; audience members are often simply en route from one place to another. The demographic composition may also very, for example young students at one time of day, business commuters at another, and tourists at still another time. Frequent census-information requests would be needed to target each audience appropriately.

As a service charge may apply each time such requests are made, however, the cost having the most up-to-date information may become prohibitive.

Accordingly, there has been and still is a need to address the aforementioned shortcomings and other shortcomings associated with determining audience expected to be in the Rot of a given billboard with a reasonable degree of certainty. These needs and other needs are satisfied by the present invention.

Note that the techniques or schemes described herein as existing or possible are presented as background for the present invention, but no admission is made thereby that these techniques and schemes were heretofore commercialized or known to others besides the inventors.

### SUMMARY

The present invention is directed to a manner of operating an interactive billboard that relies on generating an audience estimate for selecting appropriate content for presentation. The audience estimate is generated without unnecessary and costly queries to third parties, but instead relies on a UAP (user-ad-profile) dataset that is preferably generated by a billboard controller.

In one aspect, the present invention provides a method of operating an interactive billboard perceptible within a region of interest including detecting an interaction event associated with the billboard, estimating an audience of users likely to be present in the region of interest by comparing characteristics of the interaction event with a UAP dataset, and selecting the content to be displayed on the billboard based at least in part on a profile of the users likely to be present. The method may further include causing one or more billboards to present the selected content.

In another aspect, the present invention provides a method including associating a user initiating an interaction event with content being presented on the billboard when the interaction event was initiated, querying a presence server to determine the users present in a Rot of the billboard, obtaining user-profile information for the users determined to be present in the Rot, associating selected users with the content based on an analysis of the user profiles, and creating association sets, each association set comprising a set of characteristics for a user. When this has been accomplished for a number of interaction events, no more queries are generated and the association sets are used as a UAP dataset for audience estimation.

In a preferred embodiment, user sets Y(i,j,k,q) are obtained in response to a presence query and having four dimensions; time k, location i, an interactive user/and content q. As multiple user sets are accumulated, the user association sets are built by determining the number of sets in which a particular user appears for a given fixed dimension. This can be done for all four dimensions being considered in this embodiment, and scores are assigned based on the user's association with each dimension. Thresholds are also established for use in audience estimation and updated periodically. The UAP dataset may be maintained from time to time by selectively generating presence queries and updating portions for the UAP dataset according to the information obtained.

In another aspect, the present invention is a billboard controller for building a UAP dataset, using the UAP dataset for audience estimation, and causing selected content to be displayed on one or more billboards based on the estimate.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a simplified block diagram illustrating a system for operating an interactive billboard according to an embodiment of the present invention.

FIG. 2 is a flow diagram illustrating a method of operating an interactive billboard according to an embodiment of the present invention.

FIG. 3 is a flow diagram illustrating a method according to an embodiment of the present invention.

FIG. 4 is a flow diagram illustrating a process according to an embodiment of the present invention.

FIG. 5 is a flow diagram illustrating a process according to an embodiment of the present invention.

FIG. 6 is a simplified block diagram illustrating a billboard controller according to an embodiment of the present invention.

### DETAILED DESCRIPTION

The present invention is directed to a manner of managing the content for display on an interactive billboard or similar device by providing audience estimates for use in content selection without the need for purchasing user presence and profile information each time such an estimate is desired.

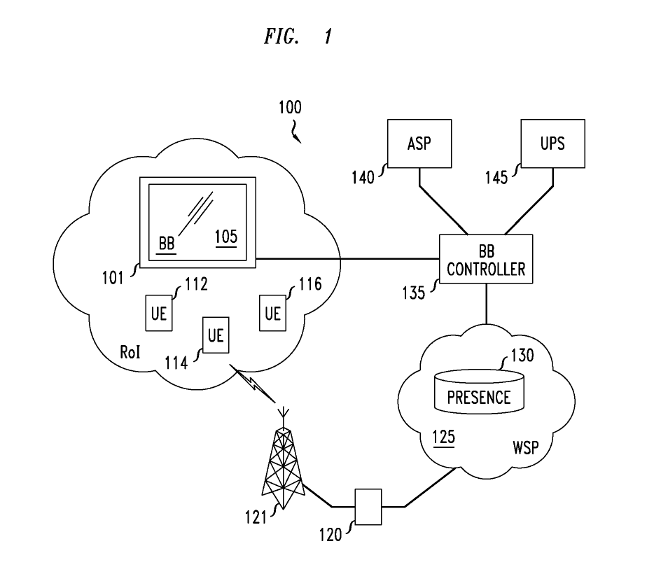

FIG. 1 is a simplified block diagram illustrating a system 100 for operating an interactive billboard according to an embodiment of the present invention. In this system there is a single billboard 101 having a display 105. Billboard 101 is located in an area where it may be seen by a relatively large number of people. Naturally, the billboard owner generally prefers a large, and in most cases relatively affluent audience, although this varies with location and except for choosing the location of the billboard, may be largely out of the operator's control. The billboard 101 may be a large roadside billboard, or a relatively smaller one in, for example, an airport, shopping mall, or sports arena.

Display 105 provides for a visible presentation to the audience. It is noted that is a few scenarios, the presentation may also have sound, vibration, or even smell associated with it. For the purpose of describing the present invention, however, these will simply be considered part of the presentation and not treated separately. The display facilitates the presentation of content, which generally is visible though it may includes other aspects are well, to change frequently and with minimal effort. Static billboards, for example, are often a flat surface with images painted or applied onto them. These may be changed as well, of course, but only by re-painting or reapplying a new image. This may take the efforts of one or more workers over the course of at least several hours, and is therefore not performed very often if the billboard owner can avoid doing so. Techniques for a more easily changed display are well known, and the precise technique used to change the visual appearance of the billboard is not relevant to describing the present invention. If there are other aspects to the presentation, such as sound, these are usually more easily changed when necessary.

Note that for convenience, a structure that includes multiple displays that can display different content simultaneously will be considered a collection of separate billboards.

As mentioned above, billboards are usually placed so as to reach out to a fairly large, if sometimes selected audience. The area in which an audience may effectually perceive the content of the presentation may be referred to as a billboard perception region. The billboard owner or operator (often the same entity) may define this or a similar area as a region of interest (RoI), which area will be used in the operation of the present invention. Although it is expected that the RoI will generally coincide with the perception region, certain areas may be added or excluded. In some cases, the RoI may be defined by someone other than the billboard operator. An RoI 110 for billboard 101 is illustrated in FIG. 1. As implied there, the RoI need not have precise boundaries. Note also that where more than one entity, for example a billboard operator and a wireless service provider (WSP), have the occasion to each take the RoI into consideration, there is typically no requirement that the RoIs considered by each coincide exactly.

Billboard 101 is an interactive billboard, meaning that people can do more than simply view its content passively. Instead they are able to send text message or use a touchpad to react to the content being displayed on the billboard in some fashion. For example, users of UE (user equipment) devices 112, 114, or 116 may be prompted to send an SMS message to a particular number in response to something they have seen. UEs 112, 114, and 116 may be, for example, mobile telephones. When a user does this, it may be referred to as an interaction event. Interaction events are significant to the billboard operator as an indication that the user is in or near the region of interest and has perceived that content is being displayed.

In the event that a user sends an SMS message, their UE may communicate with a wireless network. For example, in the embodiment of FIG. 1, UE 116 may contact base station 120 via antenna 121. A communication channel is then established though wireless network 125 to a billboard controller 135, where an interaction message of some kind is received. Note that this is a simplified explanation and many more components and steps may be involved in an actual implementation. All that is required here, however, is that the billboard operator may detect that an interaction event has occurred, and can glean some information from a received message concerning the interaction. This information may include, for example, the text of the transmitted SMS message, as well as the time that the message was sent and the location of the sender. In some cases, the location of the sender may be inferred from, for example, the time of the message and the received text.

As mentioned above, the billboard operator is interested in knowing who is located in the RoI at a given time, and one reason for this is that the content being presented may then be changed to target the current audience. In the embodiment of FIG. 1, an advertising service provider (ASP) 140 in communication with billboard controller 135 is a supplier of advertising content that may be presented on billboard 101. According to this embodiment of the present invention, billboard controller 135 assesses the audience in the RoI and then determines suitable content for display and retrieves this content from ASP 140. Alternately, an audience profile could be sent to ASP 140 and it could select suitable content. In either case, it is expected (though not required) that a record of the content displayed is kept, and that the sponsor the advertising is eventually billed accordingly.

Here it is noted that operation of the present invention is based on the well-grounded presumption assumption that a large segment of the billboard-viewing audience carries a mobile phone or other UE much of the time. The UEs may be used for interacting with the billboard, as described above, and are also used for the presence information that can typically be associated with them. The UEs may be equipped with GPS capability, for example, and report their location back to the wireless service provider (WSP) operating a wireless network. Most mobile devices also periodically register with a nearby base station, and the network keeps track of their location in this way. Triangulation or ranging involving multiple base stations may add to the precision.

In the embodiment of FIG. 1, the wireless network 125 includes a presence server 130 for tracking and recording location information relating to its subscribers and others that are using the network as visitors. Note that presence server 130 may be include more than one actual component, and is not necessarily a part of wireless network 125. In this embodiment, the WSP operating network 125 may make some or all of the presence information on presence server 130 available to billboard controller 135 as a service. In particular, billboard controller 135 may query presence server 130 to determine who is currently present in the RoI. Note that there may be more than one presence server queried by billboard controller in this fashion, perhaps to obtain user location information from other networks (not shown).

Also available to billboard controller 135 is a user profile server (UPS) 145 that collects and maintains user profile information related to various users of UE devices. When a user is discovered by billboard controller 135, a query may be made to the UPS server 145 to obtain all or a portion of this user profile information. The profile information on UPS server 145 may include, for example, demographic information, purchasing habits and trends, interests associated with the user, and recent purchases. The UPS server 145 may be maintained by the WPS or another entity, and the information stored there is of course typically available as a service. Again, more than one UPS server may be accessible to the billboard controller 135, although only one is illustrated in FIG. 1.

The billboard controller 135 may through system 101 determine with some accuracy determine who is in the Rot 110, and obtain profile information related to them before selecting advertising content and causing it to be presented on billboard 101. As mentioned above, however, continually sending queries to presence server 130 and UPS 145 or similar entities may be costly. In accordance with the present invention, billboard controller 135 also uses a UAP dataset that it either obtains or, preferably, builds itself to estimate the audience that is present in the Rot at a given time. This process will now be described in greater detail.

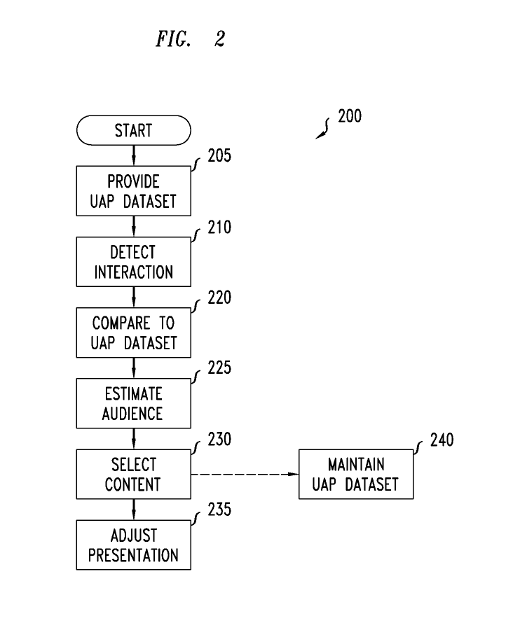

FIG. 2 is a flow diagram illustrating a method 200 of operating an interactive billboard according to an embodiment of the present invention. At START is it presumed the necessary components are present and operational according to this embodiment of the present invention. The process then begins with providing a UAP (user-ad-profile) dataset (step 205). The UAP dataset includes user data and is typically assembled during a training phase and periodically updated, although in other embodiments it may be provided to the billboard operator by another entity. The construction of a UAP dataset will be described in more detail below, but in general it contains organized information relating to the presence of users in the region of interest of one or more billboards. In a preferred embodiment, it contains scored or ranked user association sets corresponding to each user that has been found within the RoI of a billboard under the control of the billboard controller.

User interactions with a controlled billboard are anticipated. The billboard may display a given content or message, that is, the presentation visible to users in the RoI. The content at this point may be static, but in many implementations will change from time to time according to a pre-set scheme. Interaction with the billboard may be encouraged by the content itself, and interaction instruction provided, or users may be made aware of how to interact with certain billboards in some other fashion.

In the embodiment of FIG. 2, when an interaction is detected (step 210), one or more characteristics of the interaction are determined (step 215). In a preferred embodiment, these characteristics are the time Tk of the interaction, the location of the interaction (that is, an identification of the billboard Bi), the content Cq being presented by the billboard Bi at the time Tk of the interaction, and the identity of the user Xj, if it is known.

In this embodiment, the characteristics determined at step 215 are then compared (step 220) to analogous characteristics in the UAP dataset. An audience estimate is then calculated (step 225) based on the comparison of characteristics made in step 220. The audience estimate is an approximation of the users likely to be present in the RoI of a given billboard. As should be apparent, this audience estimate is used in most cases in lieu of a query to one or more service providers in order to receive a report of their subscribers that are present in the RoI. In many implementations this provides a satisfactory basis for decision-making without incurring the expense and any delay normally associated with such a query.

In a preferred embodiment, the comparison and calculation operations include comparing each of the characteristics associated with the interaction, that is, the time, location, identity of the user, and relevant content. These characteristics are compared with user associations in the UAP dataset, where the users are ranked or scored with regard to various characteristics available in a user profile, including the compared characteristics. Users with the highest scores or ranks, or scored or ranked above a particular threshold, are selected for the audience estimate. In a preferred embodiment, the scores or ranks take into account the users association with various content and in this way introduces the concept of interested groups so that the group interest may take into account the preference not only of the interacting user, but of the entire estimated audience.

Additional techniques may be applied for the comparison and calculation operations in some embodiments, including the use of more sophisticated learning algorithms such as simulated annealing, neural networks, or fuzzy logic. In some implementations these enhancements can be applied to increase the inference range, that is, further reduce the number of false negatives (users who are actually present in the ROI but not selected for the audience estimate). In another embodiment, a simple intersection algorithm is uses as a first cut prior to performing a score-based threshold evaluation.

As should be apparent, the goal of the comparison and calculation operations is to provide the most accurate audience estimate possible using the processing resources allocated for the task. In the embodiment of FIG. 2, once the audience estimate is calculated at step 225, the content is selected (step 230) according to the calculated audience.

The content selection may be based on a variety of factors, though it is anticipated that the audience estimate will at least be one factor. Other factors may include, for example, a manual override that has been imposed by the billboard operator. Other factors related to the method 200 may also be used, for example taking into account the number of interactions received over a defined period of time. And of course the content selection may include a series of presentations rather than the selection of a single static display.

Once the content is selected, the presentation on the billboard may be changed to reflect the selection (step 235). Note, however, that an indicated change in billboard presentation may in some cases be delayed or canceled. A delay or override may be imposed, for example, to prevent the presentation from being changed to rapidly, that is, after too short a time has passed since the last change. And there is no requirement that the displayed content be changed or altered each time method 200 is performed. At times the selected content will be what is currently being presented.

Optionally, the method 200 may, and in a preferred embodiment does include maintaining (step 240) the UAP dataset, an operation that will be discussed in more detail below. In some instances, the UAP dataset may be simply replaced or rebuilt. In any event, after the content selection at step 230, the process returns to step 210 when another interaction is received.

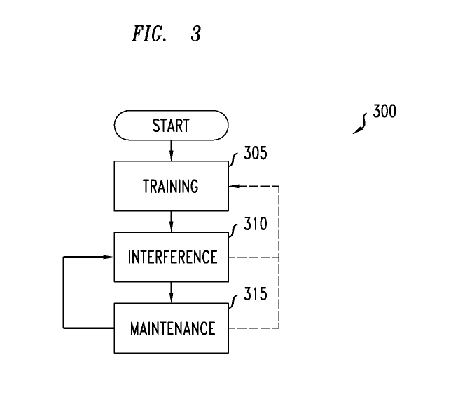

In step 205, described above, a UAP dataset is provided. In a preferred embodiment, this UAP dataset is built and maintained by the billing controller, for example, billing controller 135 shown in FIG. 1, or some related component under the control of the billboard operator. In this embodiment, the operation of the present invention may be separated into three phases, as illustrated in FIG. 3.

FIG. 3 is a flow diagram illustrating a method 300 according to an embodiment of the present invention. At START is it presumed that the necessary components are present and operational according to this embodiment of the present invention. The process then begins with the training phase (step 305), where the UAP dataset is built. In this embodiment, the UAP dataset is built using a series of presence queries, for example to the presence server 130 shown in FIG. 1, and one or more user-profile queries, for example to the UPS 145 also shown in FIG. 1. The inference phase (step 310) begins when the training phase has been completed. This may occur when a satisfactory UAP dataset has been assembled, or after a pre-determined period of time or number of queries. In the inference phase 310 audience estimates are calculated without the need to make presence or user-profile queries. This is expected to yield a cost savings in most implementations.

In the embodiment of FIG. 3, a maintenance phase (step 315) begins after the inference phase 310, to which the process returns after the maintenance phase 315 has been completed. In many embodiments, however, the maintenance may be performed selectively while the inference phase 310 is in progress. In maintenance phase 315, portions of the UAP dataset are updated or supplemented using presence or user-profile queries, or both. Optionally, the process may return to the training phase 305 at any time, for example periodically, upon the occurrence of a certain event, or as manually instructed by the billboard operator. In this case, the method 300 simply begins again.

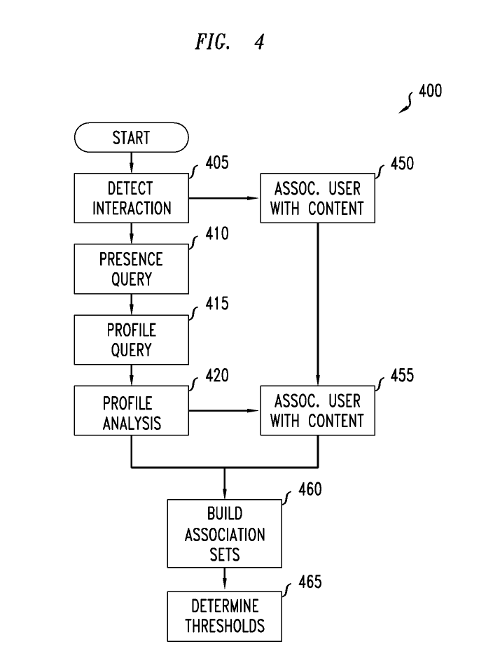

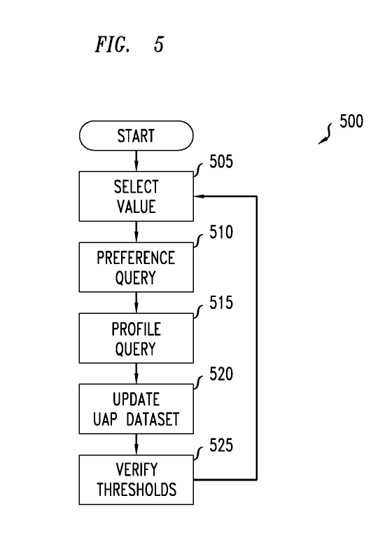

An embodiment of the inference phase is described above in reference to FIG. 2; embodiments of the training and maintenance phases will now be described with reference to FIGS. 4 and 5.

FIG. 4 is a flow diagram illustrating a process 400 according to an embodiment of the present invention. As should be apparent, process 400 is an embodiment of the training phase of the present invention. At START is it presumed that the necessary components are present and operational according to this embodiment of the present invention. In this embodiment, it is also assumed that the training phase has been initiated (not shown) in some manner. This may be done automatically as the system begins operation, or manually at the direction of the billboard operator. The illustrated process of method 400 then begins with the detection of an interaction event (step 405).

In this embodiment, when an interaction at time Tk is detected in the training phase, the user Xi associated with the interaction is identified. As mentioned above, this is typically the identification of the UE device being used for the interaction. The user Xi is then associated with the content (step 450), that is, the content Cq with which the user was interacting. Here it is presumed that the user's location Bi and the content may be inferred from the interaction, though this may not always be the case. If the billboard controller is only operating a single billboard, of course, the location and content will be apparent.

In the embodiment of FIG. 4, upon detecting an interaction event, a presence query is sent (step 410) to a WSP (or multiple WSPs) to obtain a set of users Y(i,j,k,q) who are found in the RoI. A user-profile query is then sent (step 415) to obtain a user profile for each user in set Y(i,j,k,q). Preferably, profiles retrieved from a UPS (for example UPS 145 shown in FIG. 1) are saved at the billboard controller to avoid repeated queries to the UPS for a single user. The retrieved profiles are then analyzed (step 420) to identify users likely to have a high degree of interest in the content Cq. In this embodiment, each of the users identified in this way are associated (step 455) with the content Cq as well. The users associated with content Cq form a content set CSq, that is, content set CSq is a set of users that have viewed a particular content q. Here of course the users discovered in the Rot that are likely to have a high interest in the content Cq are presumed to have actually viewed it. In association with each user, content sent CSq contains Y(i,j,k,q) for a particular q (and any combination of i,j, and k.). A score is assigned to each user added to CSq, initialized for example at 1. A user's score is incremented each time the user is associated with content Cq (at steps 450 or 455). This incremental scoring continues as each interaction is received until the training phase is terminated (not shown).

In this embodiment, user set Y(i,j,k,q) is a set of users obtained in response to a presence query and having four dimensions; time k, location i, an interactive user/and content q. As multiple user sets are accumulated, user association sets are built (step 460) by determining the number of sets in which a particular user appears for a given fixed dimension. This can be done for all four dimensions being considered in this embodiment, and scores are assigned (not separately shown) based on the user's association with each dimension.

For one example, consider the location of the billboard as the fixed dimension. For this location, a user's score is incremented for each time of day, for example 9 o'clock am, at which the user is present when an interactive event is detected. The user score is also incremented for each interacting user, for example Xi, triggering in interaction where the user is found in the RoI. In his example if the user has been discovered in the RoI at 9 am on two occasions, and has been also discovered in the RoI twice when user Xi has interacted with the billboard, a score of 4 may be assigned to indicate the relative likelihood of finding the user in the RoI at 9 am when Xi is present.

As another example, a user found in the RoI for the first time and associated with a particular content q may be given a score of 1 in content set CSq. If that user is not encountered in the RoI again during the training or maintenance phase, the user's score remains at 1.

In this manner, a database of users that have been found in each RoI is created, with each user having four types of arrays, one for the contents, one for the locations of the billboards, one for the times of the day, and one for the various interacting users. Each of these arrays contains a score for the various types of the data in that dimension. The accumulation of user sets and building of user association sets continues until the training phase has been terminated. Preferably this occurs when a satisfactory level of training data has been acquired along each of these dimensions. The data is now referred to as a UAP dataset. At this point thresholds should also be determined (step 465) for use in the inference phase.

FIG. 5 is a flow diagram illustrating a process 500 according to an embodiment of the present invention. As should be apparent, process 500 is an embodiment of the maintenance phase of the present invention. At START it is presumed that the necessary components are present and operational according to this embodiment of the present invention. The process then begins with selecting a value along each of the four dimensions; time, location, content, and user identity (step 505). The value may be selected at random or according to predetermined criteria. A query is made to determine the presence of users in the RoI (step 510), and a user-profile query is made (step 515), for example to UPS 145 shown in FIG. 1.

In the embodiment of FIG. 5, the information returned from these queries is then used to update the UAP dataset (step 520) and to verify the accuracy of the threshold values (step 525) used in the inference phase, updating the thresholds as necessary. The process continues with selecting additional values for verification at the discretion of the billboard operator. Note that in practice the frequency of maintenance operations may depend on the cost associated with doing so and the desired level of accuracy of the UAP dataset.

Here is noted that the methods presented above are exemplary, and the sequences of operation may be altered in other embodiments. In addition, other operations may be added, and in some cases depicted operations omitted, without departing from the spirit of the invention.

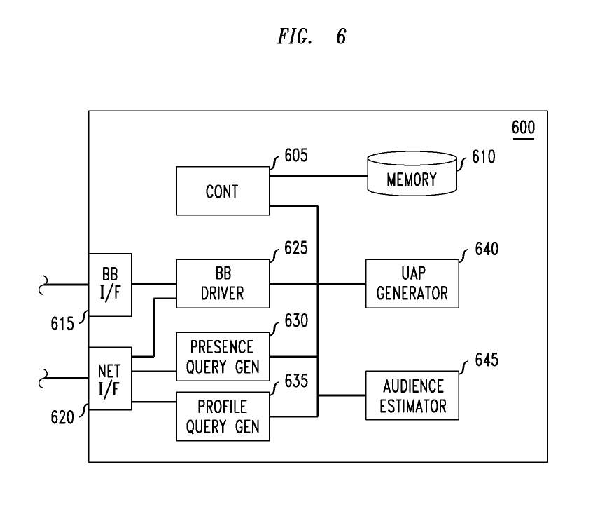

FIG. 6 is a simplified block diagram illustrating a billboard controller 600 according to an embodiment of the present invention. In this embodiment billboard controller 600 includes a device controller 605 for controlling the operation of the components of billboard controller 600, and a memory device 610 accessible by billboard controller 600 for storing data and software instructions for execution by controller 600 and perhaps other components of billboard controller 600.

In accordance with this embodiment of the present invention, billboard controller 600 also includes a billboard driver 625 for requesting and obtaining content from an ASP, and causing the content to be presented on one or more billboards via billboard interface 615. A network interface 620 is also present for requesting and receiving content from the ASP, and for sending queries generating by presence query generator 630 and user-profile query generator 635. In this embodiment, a UAP dataset generator 640 is also present for generating at least one UAP dataset for use by audience estimator 645.

Note this configuration is exemplary and may vary from one embodiment to another. Additional components may be present, of course.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method of operating an interactive billboard perceptible within a region of interest, comprising:
detecting an interaction event associated with the billboard;
estimating an audience of users likely to be present in the region of interest; and
selecting the content to be displayed on the billboard based at least in part on a profile of the users likely to be present.

2. The method of claim 1, further causing the determined content to be displayed.

3. The method of claim 1, wherein determining the set of users likely to be present comprises comparing at least one characteristic associated with the interactive event message to a user-ad-profile (UAP) dataset.

4. The method of claim 3, wherein the at least one characteristic comprises the identity of the user initiating the interaction.

5. The method of claim 3, wherein the at least one characteristic comprises the time that the interaction was initiated.

6. The method of claim 3, wherein the at least one characteristic comprises the content being displayed when the interaction was initiated.

7. The method of claim 3, wherein the billboard controller controls a plurality of billboards, and wherein the at least one characteristic comprises the location of the billboard associated with the interactive message.

8. The method of claim 3, wherein the at least one characteristic comprises the identity of the user initiating the interaction, the content being displayed when the interaction was initiated, the time of initiation, and the location of the billboard.

9. The method of claim 3, further comprising building the UAP dataset.

10. The method of claim 9, wherein building the USP dataset comprises:
associating a user initiating an interaction event with content being presented on the billboard when the interaction event was initiated;
querying a presence server to determine the users present in a Rot of the billboard;
obtaining user-profile information for the users determined to be present in the Rot;
associating selected users with the content based on an analysis of the user profiles; and
creating association sets, each association set comprising a set of characteristics for a user.

11. The method of claim 10, wherein creating the association sets comprises repeating the associating and obtaining steps for a plurality of interaction events.

12. The method of claim 10, wherein creating the association steps comprises scoring each user in association with at least one user characteristic.

13. The method of claim 12, wherein the characteristics comprise the location of the interaction event, the time of the interaction event, the identity of the user initiating the interactive event, and the content being present at the location when the interactive event was initiated.

14. The method of claim 13, wherein estimating the audience comprises including a user in the audience estimate if the user association-set score for at least one characteristic exceeds a threshold.

15. The method of claim 3, further comprising updating the UAP dataset.

16. The method of claim 3, further comprising adjusting at least one threshold used in estimating the audience of users.
